(19) United States
(12) Patent Application Publication
(10) Pub. No.: US 2008/0005395 A1
(43) Pub. Date: Jan. 3, 2008

(54) Adapter to convert USB device into WUSB device

(76) Inventors: Ping-Wen Ong, Laguna Niguel, CA (US); Turgut Aytur, Plattsburgh, NY (US); Venkatesh Rajendran, Irvine, CA (US)

Correspondence Address: CHRISTIE, PARKER & HALE, LLP, PO BOX 7068, PASADENA, CA, 91109-7068, US

(21) Appl. No.: 11/429,019

(22) Filed: May 5, 2006

(51) Int. Cl. G06F 3/00

(52) U.S. Cl. 710/36

(57) ABSTRACT

An adapter for coupling a wired device to either a wired host or a wireless host. The wired device may be a USB device, the wired host may be a USB host, and the wireless host may be a WUSB host. The adapter may optionally include a battery.

### BACKGROUND OF THE INVENTION

The invention relates generally to wireless devices and more particularly to wireless adapters for wired devices such as Universal Serial Bus (USB) devices.

The use of wireless communication devices for digital communications has been increasing. Digital devices which have primarily communicated with other digital devices using cables or other physical wire-type mediums are increasingly likely to be candidates for performing such communications using wireless communications.

Many wired devices communicate using a Universal Serial Bus (USB) connection and protocol, and such devices are often termed USB devices. USB devices are widely prevalent. USB devices are coupled to a USB host using a USB connector, with the USB device able to both communicate with and receive power from the USB host over the USB connector.

### BRIEF SUMMARY OF THE INVENTION

The invention provides an adapter to provide a USB device wireless capability. In some embodiments the adapter is external device, for example a dongle, coupled to a USB device. In some embodiments the adapter is within the USB device, for example a chip on a circuit board of the USB device. In many embodiments the adapter comprises an upstream USB connection, a wireless device, a downstream USB connection, and a switch for switchably coupling the downstream USB connection to either the upstream USB connection or the wireless device. In some embodiments the adapter further comprises a battery.

In one aspect the invention comprises an adapter for data coupling a Universal Serial Bus (USB) device to a USB host or a wireless USB (WUSB) host, comprising an upstream port configured for electrical coupling to a USB host; a downstream port configured for electrical coupling to a USB device; a WUSB device; and a switching unit configured to switchably data couple the upstream port and the downstream port or the WUSB device and the downstream port.

In another aspect the invention comprises a method using of data coupling a USB device to either a Universal Serial Bus (USB) host or a wireless USB (WUSB) host, comprising determining if a unit is coupled to a USB host; data coupling a USB device and the USB host if the unit is coupled to the USB host; and data coupling the USB device and a wireless device if the unit is not coupled to the USB host.

These and other aspects of the invention are more fully comprehended upon review of this disclosure.

### BRIEF DESCRIPTION OF THE FIGURES

FIG. 1 is a block diagram of a USB/wireless system in accordance with aspects of the invention;

FIG. 2 is a block diagram of an adapter in accordance with aspects of the invention;

FIG. 3 is a flow diagram of a process in accordance with aspects of the invention;

FIG. 4 is a flow diagram of a further process in accordance with aspects of the invention;

FIG. 5 is a flow diagram of a further process in accordance with aspects of the invention; and

FIG. 6 is a block diagram of a further multiple device adapter in accordance with aspects of the invention.

### DETAILED DESCRIPTION

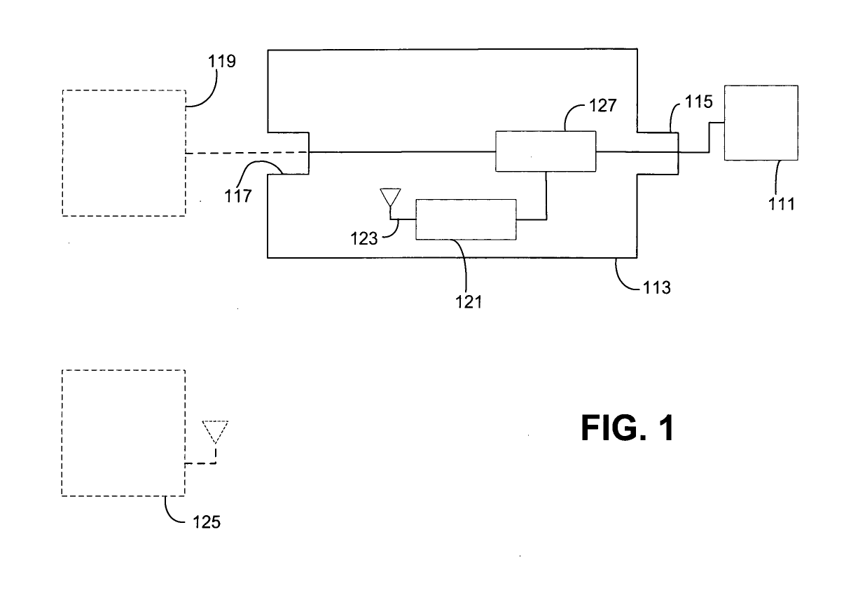

FIG. 1 is a block diagram of a system in accordance with aspects of the invention. In FIG. 1, a wired device 111, such as a USB device, is coupled to an adapter 113. The wired device may be, for example, a hard disk, a storage unit such as a CD drive, a monitor for a computer, or one of many other devices.

The adapter includes a first port 115 and a second port 117. The first port is configured for data communication with the wired device, and in many embodiments the first part is considered a downstream connection. The second port is configured for data communication with a wired host 119, such as a USB host, and in many embodiments is considered an upstream connection.

The adapter also includes a wireless device 121 and an antenna 123. The wireless device is part of the adapter. The antenna is used for wireless communication with a wireless host 125. A fork 127 routes data between the downstream connection, and thus the wired device, and either the upstream connection, and thus the wired host, or the wireless host. Preferably the wireless device is a wireless USB (WUSB) device and the wireless host is a WUSB host.

The fork in some embodiments comprises a switch or a switching unit. In many embodiments the fork additionally includes a controller or control circuitry, and may include memory. In some embodiments the controller, determines the state of the switch. In some embodiments the controller monitors the upstream connection for presence of a wired host. In some embodiments this is accomplished by monitoring the upstream connection for power, and in some embodiments this is accomplished by monitoring the upstream connection for signals generated by a wired host. The controller commands the switch to route data between the downstream connection and the upstream connection if the controller detects the presence of a wired host.

In some embodiments the controller of the adapter additionally is configured to perform a mapping function. For example, in some embodiments communication protocols or aspects for communication between a wired device and wired host may differ from communication protocols between a wireless device and a wireless host. Accordingly, for these and other reasons, the controller, or some other or additional functional block of the adapter, may perform a mapping function. In some embodiments the mapping function translates data from one communication protocol to another communication protocol.

In some embodiments the controller, or alternatively the wireless device, is configured to additionally receive information, such as device enumeration information, from the wired device and provide responses expected from a host to the wired device. Thus, the adapter may, from the viewpoint of the wired device, effectively mimic the host, particularly for set-up, initialization, and/or enumeration purposes.

In some embodiments the adapter of FIG. 1 is configured for operation with a USB device and either a USB host or a WUSB host. In such an embodiment, for example, the upstream port 117 may be an upstream USB connection. The upstream USB connection is coupled to a USB host 119, such as a computer. In an embodiment, the upstream USB connection extends from the adapter and is optionally plugged into the USB host. The wireless device 121 may be a WUSB communications system. The WUSB communications system generally includes a wireless transceiver for data communicating wirelessly to a WUSB host or access point associated with the WUSB host. Similarly, the downstream port 115 may be a downstream USB connection. In an embodiment, the downstream USB connection extends from the adapter and is optionally plugged into the USB device. The fork, or other circuitry of the adapter may, in most embodiments, provide and execute instructions to carry out communications between the USB device and the host. Thus, the fork may use the USB protocol to communicate with the USB device. The fork may also be configured as a WUSB device for communication with the WUSB host. Thus, in an embodiment, the fork becomes the agent for the USB device, relaying traffic between the WUSB host and the USB device.

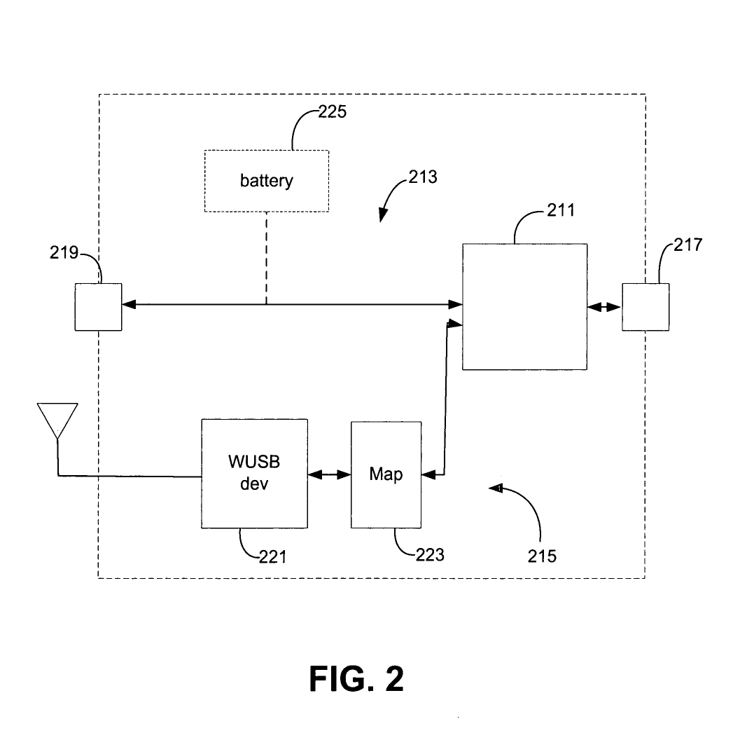

FIG. 2 is a block diagram of an adapter in accordance with aspects of the invention. The adapter includes a switching unit 211 for switching data between either a first data path 213 or a second data path 215. The first data path couples a downstream connector 217 to an upstream connector 219 through the switching unit. The second data path couples the downstream connector to a WUSB device 221.

A mapping unit 223 is interposed in the data path between the switching unit and the WUSB device. The mapping unit performs mappings between a WUSB protocol and a USB protocol. Thus, with the switching unit routing data on the second data path, data sent from the USB device to the WUSB device is mapped from a USB protocol to a WUSB protocol. The WUSB device then communicates wirelessly with a WUSB host using the WUSB protocol. In some embodiments, however, the mapping function is performed by the WUSB device.

In some embodiments the WUSB device is also configured to perform some functions commonly associated with a USB host. For example, in some embodiments the WUSB device is configured to communicate with a USB device for purposes of allowing for USB device enumeration. In some embodiments, however, this capability is provided by a controller (which may be part of the switching unit) of the adapter or a mapping block of the adapter. Thus, in many embodiments the adapter emulates a host, at least for wired device setup functions and serves, when considered from the view of the wired device, as a host.

An optional battery 225 may also be connected to the first switching path, with the optional battery providing power to the adapter, preferably when the second data path is active. The battery will generally charge when the first data path is active, if the adapter is coupled to a USB host providing power.

In operation of some embodiments, the switching unit couples the upstream connector to the downstream connector when the downstream connector is connected to a USB device and the upstream connector is connected to a USB host. In such an instance, the USB device receives power sourced by the USB host, and the adapter may be consider merely a wire (or, more suitably, wires) coupling the USB host and the USB device. For convenience, such an instance may be termed a USB wire mode of operation. In the USB wire mode of operation the battery of the adapter, if present, may also be charged using the power sourced by the USB host.

In various embodiments the switching unit couples the WUSB device to the downstream connector when the upstream connector is not connected to a USB host. In some embodiments the presence of a USB device connected to the downstream connector is also required for the switching unit to couple the WUSB device to the downstream connector. The adapter may receive power from the battery, if present, or from a power input provided by the USB device, such as may occur when the adapter is configured as a chip on a USB circuit board. For convenience, such an instance may be considered a WUSB self-powered mode of operation. Alternatively, the adapter may receive power through the upstream connection, without the upstream connection being coupled to a USB host. For convenience, such an instance may be considered a WUSB external-powered mode of operation.

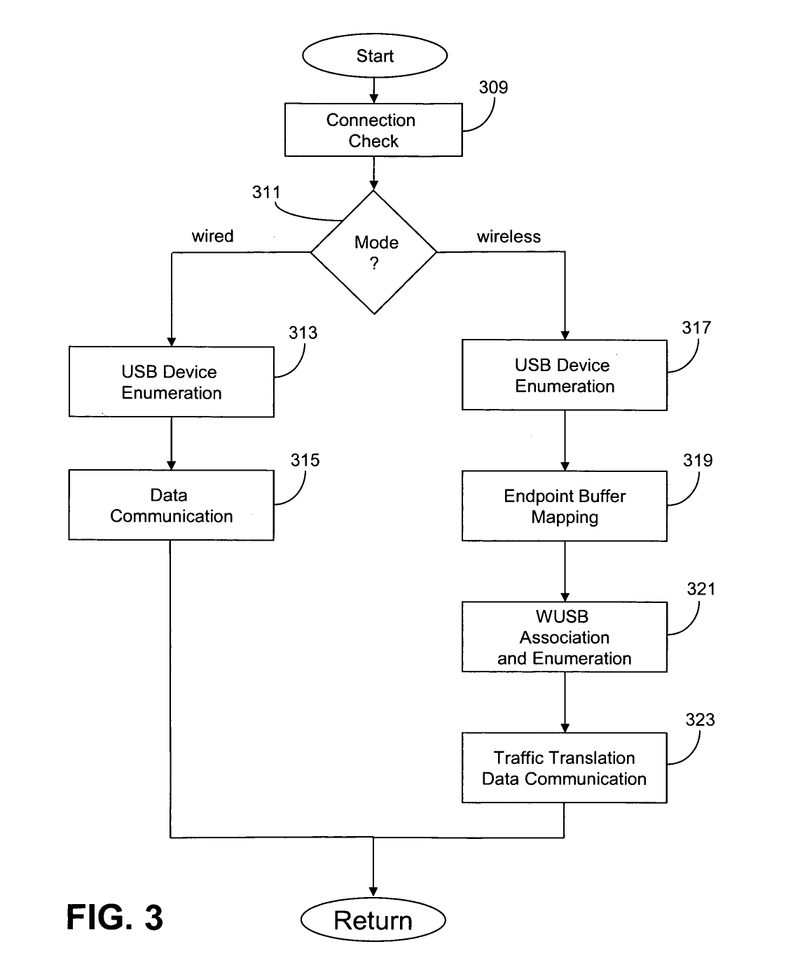

FIG. 3 is a flow diagram of a process of an embodiment of operation of an adapter. In block 309 the process determines if a device has a wired connection to an upstream host. In some embodiments, the process determines if a power signal or control signal is present on a connection or line coupled to a connection. In some embodiments, the process monitors reception by a wireless receiver and determines if the device has a wireless connection to an upstream wireless host.

In block 311 the process determines a mode of operation. The mode of operation may be a wired mode or a wireless mode. In some embodiments the process selects a wired mode if a device has a wired connection to an upstream host. In some embodiments the process selects a wired mode if a device has both a wired connection to an upstream host and a wireless connection to a wireless host. In some embodiments the process selects a mode responsive to a switch on the device or responsive to a mode selection software operable on the upstream host or wireless host. In some embodiments, the process selects a wireless mode if a device has a wireless connection to a wireless host.

If the mode is wired, the process continues to block 313. In block 313, the process performs USB device enumeration between a USB device and a USB host. USB device enumeration includes, in various embodiments, a process for determining the speed and type of the USB device, assigning addressing information, and processing instructions to initialize and configure the USB device. In some embodiments, the process emulates the USB host and communicates with the USB device to perform enumeration. In many embodiments, however, the process performs enumeration by providing enumeration-related information, provided by the USB device, to the USB host and providing enumeration related information, provided by the USB host, to the USB device, if any. In block 315 the process communicates data between the USB device and the USB host and, optionally, charges an internal battery. The process afterwards returns.

If the mode is wireless, the process continues to block 317. In block 317, the process performs USB device enumeration between the USB device and the WUSB device. In many embodiments the WUSB device is the adapter. In block 319, the process maps endpoints of the USB device to endpoints of the WUSB device. The process of block 319, for example, includes determining the endpoint addresses of the USB device, determining endpoint addresses of the WUSB device, and determining a set of corresponding mapped addresses.

In block 321, the process performs WUSB association and enumeration. During WUSB association, a WUSB device associates with a WUSB host, generally through a handshaking procedure. In some embodiments, WUSB association includes authentication. Generally, in WUSB enumeration, the process communicates information to the WUSB host including the mapped addresses, class of product, number and type(s) of endpoints, device descriptor, configuration descriptor, and string descriptor.

In block 323, the process converts WUSB data from the WUSB host into USB data and communicates it to the USB device and/or converts USB data from the USB device into WUSB data and communicates it to the WUSB host The conversion of WUSB data from the WUSB host into USB data may include processing the WUSB data. If the USB data is encapsulated within WUSB data, processing the WUSB data may include removing header and footer information from the WUSB data and reformatting the data into a format that can be used by the USB device. In an embodiment, converting USB data into WUSB data may include encapsulating the USB data into WUSB data or adding header and footer information.

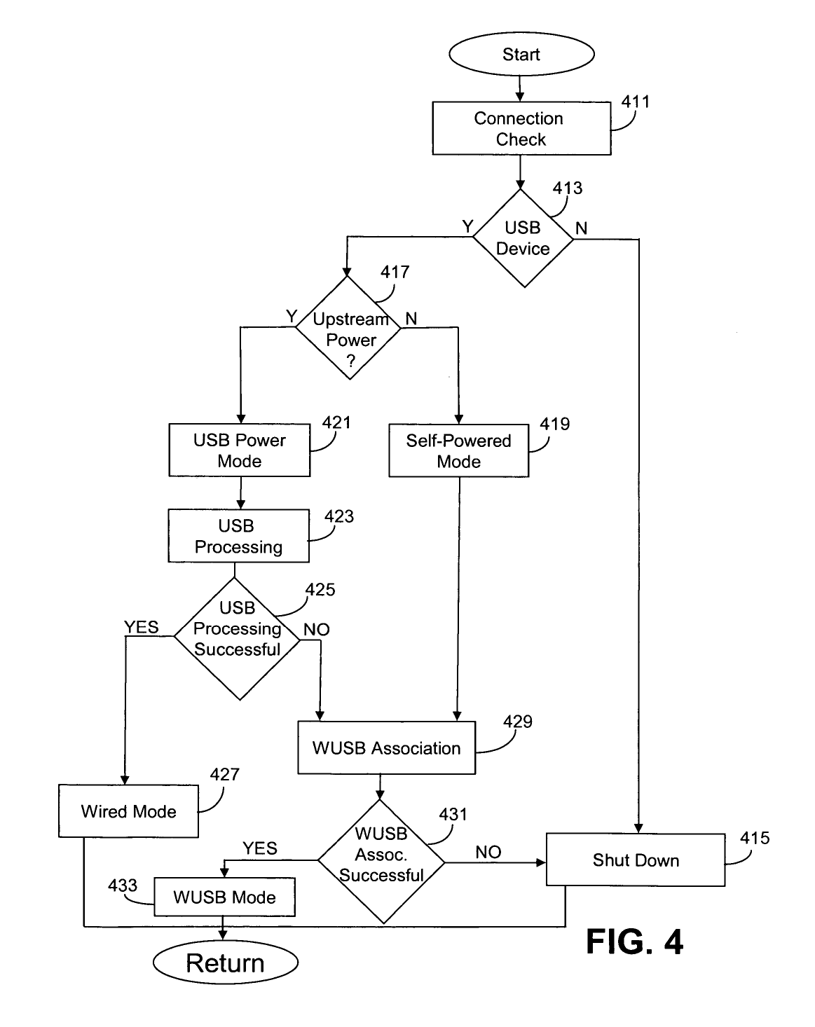

FIG. 4 is a flow diagram of a further process of an embodiment of operation of an adapter including mode selection. The process may be performed, for example, by programmable or other circuitry of the adapter. In block 411, the process checks connections. In many embodiments, checking connections includes attempting to communicate with at least one device attached to a port of the adapter. In block 411, for example, the process may determine if there is a USB device coupled to a downstream port of the adapter and/or if a power source is coupled to an upstream port of the adapter or if communications can be established with a host coupled to the upstream port.

In block 413, if the process determines that a USB device is coupled to the downstream port, the process continues to block 417 and determines if upstream power is available. If the process determines no USB device is coupled to the downstream port, the process continues to block 415 and shuts down.

In block 417, the process determines if power is received at the upstream port. If power is received at the upstream port, the process continues to block 421 and USB power mode. If the process determines that power is not received at the upstream port, the process continues to block 419 and self-powered mode.

In block 419, the process selects self-power mode. In an embodiment, self-power mode includes using a battery or batteries or a wired power surge to receive power and provide power to the USB device. In an embodiment, self-power mode includes a low-power mode.

In block 421, the process selects USB power mode. In an embodiment, power mode includes receiving power from the USB host and providing power to the USB device.

In block 423, the process performs USB processing enabling and monitoring communication between the USB device and the USB host. In some embodiments, the process in block 423 determines that the USB processing was successful if the USB device and USB host establish a data connection.

In block 425, if the USB processing in block 423 was successful, the process continues to block 427 and wired mode. If the USB processing in block 423 was unsuccessful, the process continues to block 429 for WUSB processing. In an embodiment, a hardware switch or software toggle may override the decision of block 425, allowing the process to continue to block 429 although USB processing is successful. In other embodiments, the switch or toggle may be placed at other blocks.

In block 427, the process selects wired mode. In an embodiment, wired mode includes operably coupling the USB device and the USB host. In some embodiments, wired mode includes receiving information from the USB device and passing the information to the USB host. In some embodiments, wired mode includes receiving information from the USB host and passing the information to the USB device. In some embodiments, wired mode includes passing information from the USB host to the USB device and vice-versa. In some embodiments wired mode additionally includes performing signal conditioning, for example amplification, of signals indicative of the information.

In block 429 the process performs WUSB association. In some embodiments, WUSB association includes communicating with a WUSB host or an access point associated with a WUSB host. WUSB association generally includes monitoring one or more channels to determine the presence of a WUSB host, selecting a WUSB host, and communicating with the WUSB host including an authentication process. In some embodiments, the process in block 429 determines that the WUSB association was successful if the WUSB host and process successfully perform a handshake procedure.

In block 431, if the WUSB association in block 429 was successful, the process continues to block 431 and WUSB mode. If the WUSB association was unsuccessful, the process continues to block 415 and shuts down.

In some embodiments in Block 415 the process enters a shutdown mode that includes powering off the adapter. In some embodiments, the process waits for a connection and returns to another block.

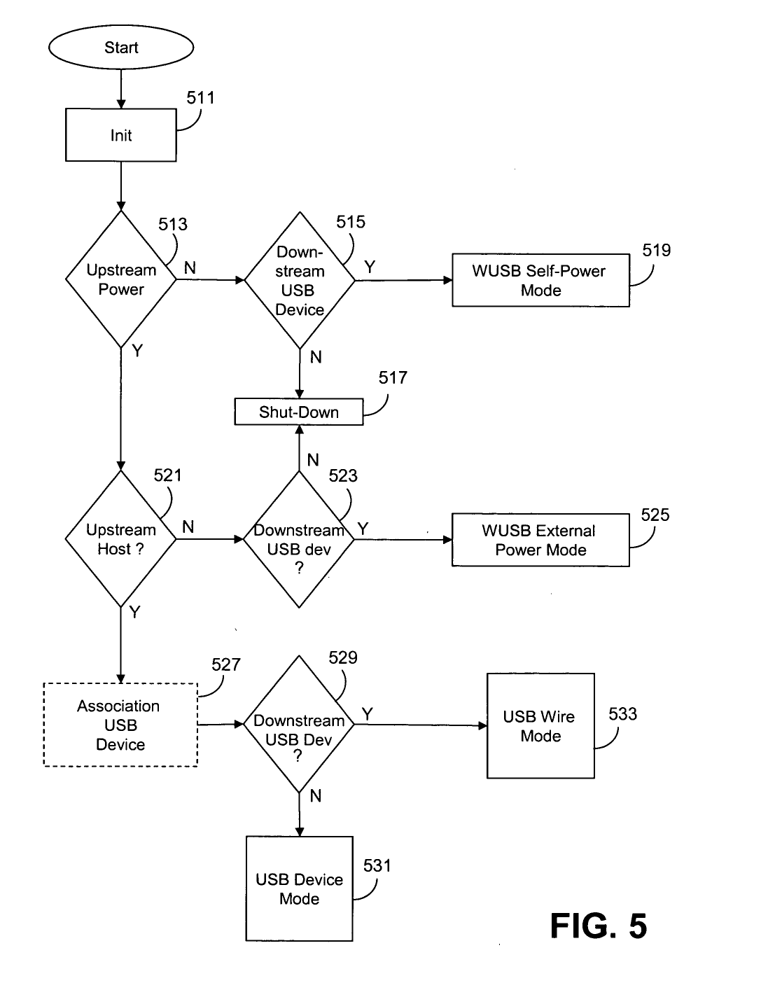

FIG. 5 is a flow diagram of a further process in accordance with aspects of the invention including mode selection. In block 511 the process performs initialization functions. In some embodiments initialization functions include power up and initial boot of an adapter. In block 513 the process determines if the adapter receives power on its upstream port. If the process determines the adapter is not receiving power on its upstream port the process goes to block 515. In block 515 the process determines if the adapter's downstream port is coupled to a USB device. In some embodiments the process determines if the adapter has a USB device coupled to the adapter's downstream port by providing an interrogation signal on the connections to the downstream port. If the process determines that no USB device is coupled to the downstream port, the process goes to block 517 and shuts down the adapter.

If the process determines in block 515 that a USB device is coupled to the downstream port of the adapter, the process enters WUSB self-power mode in block 519. In WUSB self-power mode the process configures the adapter to receive power from, for example, a battery optionally included with the adapter. In some embodiments the adapter is configured to receive power from a circuit board, for example a circuit board of a USB device, and the adapter configures the adapter to receive power from the circuit board.

If, in block 513, the process determines that upstream power is received at the upstream port of the adapter, the process continues to block 521. In block 521 the process determines if a USB host is coupled to the upstream port. If no USB device is coupled to the upstream port, the process continues to block 523. In block 523 the process determines if a USB device is coupled to a downstream port of the adapter. If no USB device is coupled to the downstream port, the process continues to block 517 and shuts down the adapter. If, however, the process determines that a USB device is coupled to the downstream port, the process configures the adapter for operation in WUSB external power mode in block 525. In WUSB external power mode, the adapter receives power from the upstream port of the adapter.

If, in block 521, the process determines that the upstream port of the adapter is coupled to a USB host, the process proceeds to optional block 527. In block 527 the process commands the adapter to perform a USB/WUSB association. In the USB/WUSB association, the process performs an association function to obtain a connection context as a WUSB device. Performance of the association function by way of an upstream USB port allows the WUSB device to receive a connection context and otherwise perform association functions in a more secure manner than occurs using wireless communications.

The process thereafter continues, or continues after performing the functions of block 521, to block 529. In block 529 the process determines if a USB device is coupled to the downstream port of the adapter. If no USB device is coupled to the downstream port of the adapter, the process continues to block 531. In block 531 the process enters USB device mode. In some embodiments, USB device mode means that the process configures the adapter to maintain sufficient communication with the WUSB device to maintain the connection context. In some embodiments, USB device mode means that the process commands the adapter to maintain the connection context in the memory for a period of time, or alternatively until a USB device is coupled to the downstream port of the adapter for later communication.

If in block 529 the process determines that a USB device is coupled to the downstream port of the adapter, the process proceeds to block 533. In block 533 the process configures the adapter for communication in USB wire mode. In USB wire mode the adapter passes information of signals between the upstream port and the downstream port. In some embodiments entering a USB wire mode is performed by resetting of the device.

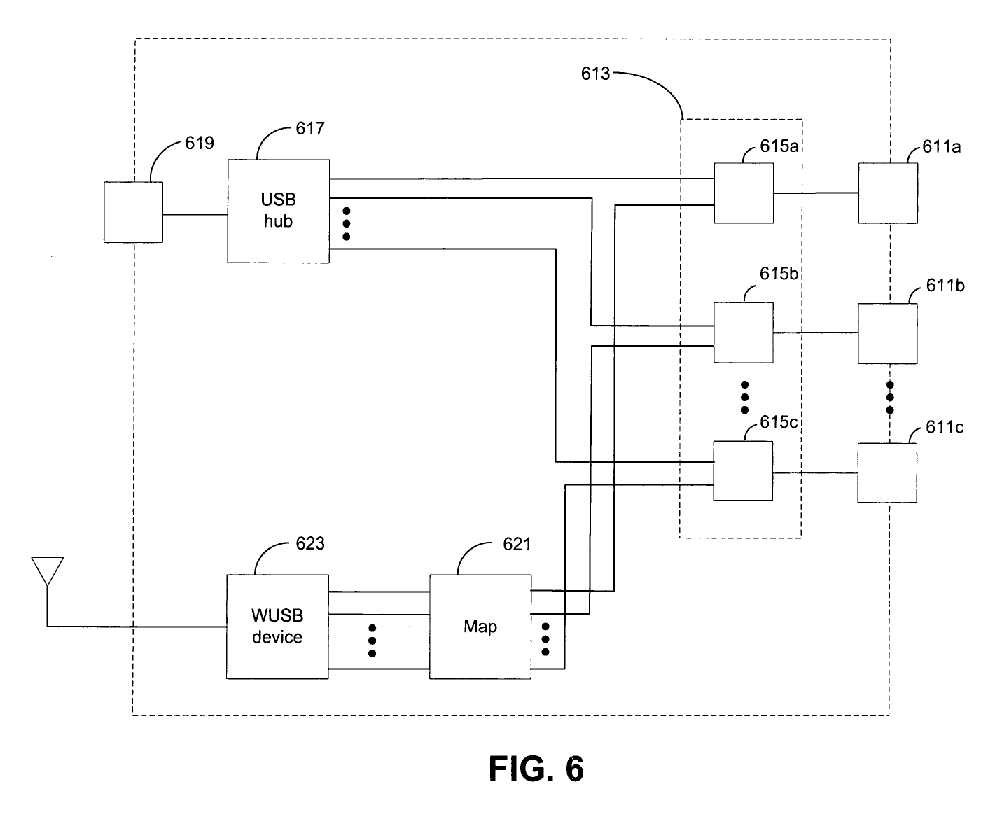

FIG. 6 is a block diagram of a further embodiment of an adapter in accordance with aspects of the invention. The adapter of FIG. 6 includes multiple downstream ports 611a-c allowing for coupling of multiple USB devices to the adapter. Although for clarity only three downstream ports are illustrated in FIG. 6, it should be recognized that in various embodiments the number of downstream ports may be fewer or greater.

Each of the downstream ports is coupled to fork circuitry 613 in the adapter. As illustrated, the fork circuitry includes multiple forks 615a-c. The forks in various embodiments include switching and/or control circuitry as, for example, described with respect to FIGS. 1 and 2. Each of the forks switchably couple information from the downstream ports to either a USB hub 617 and an upstream port 619 or a mapping block 621 and WUSB device 623.

The USB hub may include, for example, a routing block, a traffic translator, and other items commonly found in USB hubs.

The mapping block includes circuitry for mapping USB device endpoints to WUSB device endpoints. Optionally, the mapping block also includes circuitry for providing and/or receiving information to or from the WUSB device in a controlled manner. For example, in some embodiments the WUSB device is configured to communicate information relating to a specific USB device in a time sharing manner, such as a round robin timesharing manner.

Preferably the WUSB device identifies itself to a WUSB host as a different device for each USB device coupled to the adapter. In such a manner the WUSB host may allocate increased bandwidth to the WUSB device.

Although the invention has been described with respect to certain specific embodiments, it should be recognized that the invention comprises the claims and their insubstantial variations supported by this disclosure.

What is claimed is:

1. An adapter for data coupling a Universal Serial Bus (USB) device to a USB host or a wireless USB (WUSB) host, comprising:
an upstream port configured for electrical coupling to a USB host;
a downstream port configured for electrical coupling to a USB device;
a WUSB device; and
a switching unit configured to switchably data couple the upstream port and the downstream port or the WUSB device and the downstream port.

2. The adapter of claim 1 further comprising control circuitry configured to determine if power is received by the upstream port.

3. The adapter of claim 2 wherein the control circuitry is further configured to command the switching unit to data couple the downstream port and the WUSB device if power is received by the upstream port.

4. The adapter of claim 3 wherein the control circuitry is further configured to determine if a USB device is coupled to the downstream port.

5. The adapter of claim 1 further comprising mapping circuitry configured to map endpoints of the USB device to endpoints of the WUSB device.

6. The adapter of claim 5 wherein the mapping circuitry is part of the WUSB device.

7. The adapter of claim 5 wherein the mapping circuitry is part of the control circuitry.

8. The adapter of claim 5 wherein the mapping circuitry is part of a mapping block disposed on a data path between the switching unit and the WUSB device.

9. The adapter of claim 1 further comprising:
a plurality of downstream ports each configured for electrical coupling to a corresponding USB device, with the downstream port being one of the plurality of downstream ports; and
a USB hub interposed between the upstream port and the plurality of downstream ports.

10. The adapter of claim 9 further comprising a plurality of switching units each configured to switchably data couple a corresponding downstream port and the upstream port or the corresponding downstream port and the WUSB device.

11. The adapter of claim 1 further comprising a battery configured to provide power to the adapter.

12. A method using of data coupling a USB device to either a Universal Serial Bus (USB) host or a wireless USB (WUSB) host, comprising:
determining if a unit is coupled to a USB host;
data coupling a USB device and the USB host if the unit is coupled to the USB host; and
data coupling the USB device and a wireless device if the unit is not coupled to the USB host.

13. The method of claim 12 further comprising data coupling the wireless device to a WUSB host.

14. The method of claim 13 further comprising mapping endpoints of the USB device and the wireless device.

15. The method of claim 12 wherein determining if a unit is coupled to a USB host comprises determining if the unit is receiving power on a port configured for electrically coupling with the USB host.

16. The method of claim 12 further comprising receiving power on a port configured for coupling the unit with a USB host.

17. The method of claim 12 further comprising determining if power is provided to a port of the unit configured for coupling with the USB host.

18. The method of claim 17 further comprising drawing power from a battery of the unit if power is not provided to the port of the unit configured for coupling with the USB host.

19. The method of claim 17 further comprising drawing power from a circuit board associated with the unit if power is not provided the port of the unit configured for coupling with the USB host.

20. The method of claim 12 further comprising:
data coupling a plurality of USB devices and the USB host if the unit is coupled to the USB host, the USB device being one of the USB devices; and
data coupling the plurality of USB devices and at least one wireless device if the unit is not coupled to the USB host.

21. The method of claim 20 further comprising data coupling the wireless device and a WUSB host.

22. The method of claim 21 further comprising identifying the wireless device as a plurality of WUSB devices to the WUSB host.
